(19) United States
(12) Patent Application Publication
(10) Pub. No.: US 2016/0326782 A1
(43) Pub. Date: Nov. 10, 2016

(54) ACCESS HANDLE SYSTEM FOR A MOTOR VEHICLE

(71) Applicant: FORD GLOBAL TECHNOLOGIES, LLC, Dearborn, MI (US)

(72) Inventors: James Hadley Muiter, Plymouth, MI (US); Scott Holmes Dunham, Redford, MI (US)

(21) Appl. No.: 14/703,921

(22) Filed: May 5, 2015

(51) Int. Cl. E05B 85/10

(52) U.S. Cl. CPC E05B 85/10

(57) ABSTRACT

An access handle system for a motor vehicle incorporates a handle carried on the motor vehicle adjacent the tailgate closure. The handle is displaceable between a storage position and a deployed position about an axis A and adjustable between at least a first position and a second position by translation along the axis A.

### TECHNICAL FIELD

This document relates generally to the motor vehicle field and, more particularly, to an access handle system that provides assistance to an individual that is entering or leaving a storage area of the motor vehicle.

### BACKGROUND

The degree of ease with which a person can enter and exit a storage area of a motor vehicle (such as the bed of a pickup truck), safely and conveniently, has become a measure of the usefulness of the vehicle itself. Toward this end, U.S. Pat. No. 8,919,853 owned by Ford Global Technologies, LLC, discloses an integrated step and grab-handle system for the tailgate of a pickup truck. More specifically, the system includes a step and a cooperating pole handle which may both be deployed from the tailgate of the vehicle in order to allow one to more conveniently access the bed area of the vehicle.

This document relates to an alternative access handle system that is relatively inexpensive and that provides additional function.

### SUMMARY

In accordance with the purposes and benefits described herein, an access handle system is provided for a motor vehicle including, for example, a pickup truck or a sport utility vehicle (SUV). In one possible embodiment, that system comprises a handle and a biasing element for displacing the handle from a storage position to a fully deployed position when a closure of the motor vehicle is opened. For purposes of this document a closure includes a tailgate such as found on a pickup truck as well as a liftgate such as found on an SUV.

In one possible embodiment, the handle is received in a recess in a body panel of the motor vehicle when in the storage position. That recess may be formed in a sidewall of a cargo bed that is accessed when the tailgate closure is opened.

In one possible embodiment, the access handle system further includes a lock assembly for securing the handle in at least one of the deployed position and the storage position. That lock assembly may include a latch pin for engaging and holding the handle in the deployed position and an actuator on the tailgate closure for releasing the latch pin when the tailgate closure is closed so that the handle is free to be displaced into the storage position.

In another possible embodiment, the access handle system comprises a handle carried on the motor vehicle adjacent the closure wherein that handle is (a) displaceable between a storage position and a deployed position about an axis A and adjustable between at least a first position and a second position by translation along that axis A. In one possible embodiment, that handle assembly further includes a lock assembly for securing the handle in at least one of the home position, the deployed position, the first position and the second position.

In one possible embodiment, the handle assembly further includes a flexible cargo net and a payout reel for the flexible cargo net. That flexible cargo net includes a distal end having a hook for securing the distal end to the handle.

In yet another possible embodiment, the handle assembly includes a second handle carried on the motor vehicle adjacent an opposite side of the closure. That second handle is displaceable between a storage position and a deployed position about an axis B and adjustable between at least a third position and a fourth position by translation along the axis B.

In this embodiment, the handle assembly may further include a flexible cargo net having a first hook at a first end and a second hook at a second end whereby the flexible cargo net may be connected to and extended between the handle and the second handle. In yet another possible embodiment the handle assembly may include a flexible cargo net and a payout reel for the flexible cargo net wherein the payout reel is housed within the handle.

In any of the embodiments of the access handle system, the handle may be fixed to a handle support that rotates about the axis A. Further that handle support includes a guide track along which the handle translates between at least the first and second positions.

In yet another possible embodiment, the handle is articulated at a single point perpendicular to the axis A. In still another embodiment, the handle is articulated at two points offset from the axis A. Advantageously, the articulation of the handle in either of these embodiments adds to the adjustability and versatility of the access handle system by allowing the handle to be positioned virtually anywhere a user finds it to be most useful for any particular application.

In still another possible embodiment, the access handle system includes a biasing element for displacing the handle from the storage position to the fully deployed position when the closure is opened. Further, the handle may be received in a recess in a body panel of the motor vehicle when in the storage position where it is completely free and clear of the closure opening.

In yet another possible embodiment, the access handle system for a motor vehicle comprises a recess provided in a rear quarter panel of the motor vehicle and a handle carried on the rear quarter panel and displaceable between a home position wherein the handle is received in the recess with a facing of the handle flush with an outer surface of the rear quarter panel and a deployed position wherein the handle and the facing project outwardly from the rear quarter panel, where it may be easily grasped by a user when desired. In one possible embodiment that handle is automatically deployed when a closure of the motor vehicle is opened. In another possible embodiment, that handle is automatically displaced to the storage position when a closure of the motor vehicle is closed.

In the following description, there are shown and described several preferred embodiments of the access handle system. As it should be realized, the access handle system is capable of other, different embodiments and its several details are capable of modification in various, obvious aspects all without departing from the access handle system as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the access handle system and together with the description serve to explain certain principles thereof. In the drawing figures:

FIG. 1 is a rear perspective view of a pickup truck equipped with one possible embodiment of the access handle system that is the subject matter of this document.

FIGS. 2a-2c are a series of top plan views illustrating how the handle in embodiment 1 is pivoted from the deployed position to the storage position when the tailgate is closed.

FIG. 3 is a perspective view of a second possible embodiment of the access handle system including a flexible cargo net.

FIG. 4 is a perspective view of a third possible embodiment of the access handle system including a retractable cargo net and a lock assembly for securing the handle in a deployed position.

FIG. 5 is a schematic block diagram of the lock assembly.

FIG. 6 is a perspective view of yet another embodiment further including vertical height adjustment capability.

FIG. 6a is a detailed cross-sectional view of the pivotable handle support and longitudinal guide track of the FIG. 6 embodiment.

FIGS. 7a and 7b are perspective views of still another embodiment which includes a handle that projects outwardly from the rear quarter panel of the motor vehicle when deployed.

FIG. 8 is a perspective view of an additional possible embodiment including a handle that articulates at one point allowing additional adjustability.

FIGS. 9, 10, 10a and 10b illustrate yet another embodiment with a handle that articulates at two points to allow additional adjustability.

Reference will now be made in detail to the present preferred embodiments of the access handle system, examples of which are illustrated in the accompanying drawing figures.

### DETAILED DESCRIPTION

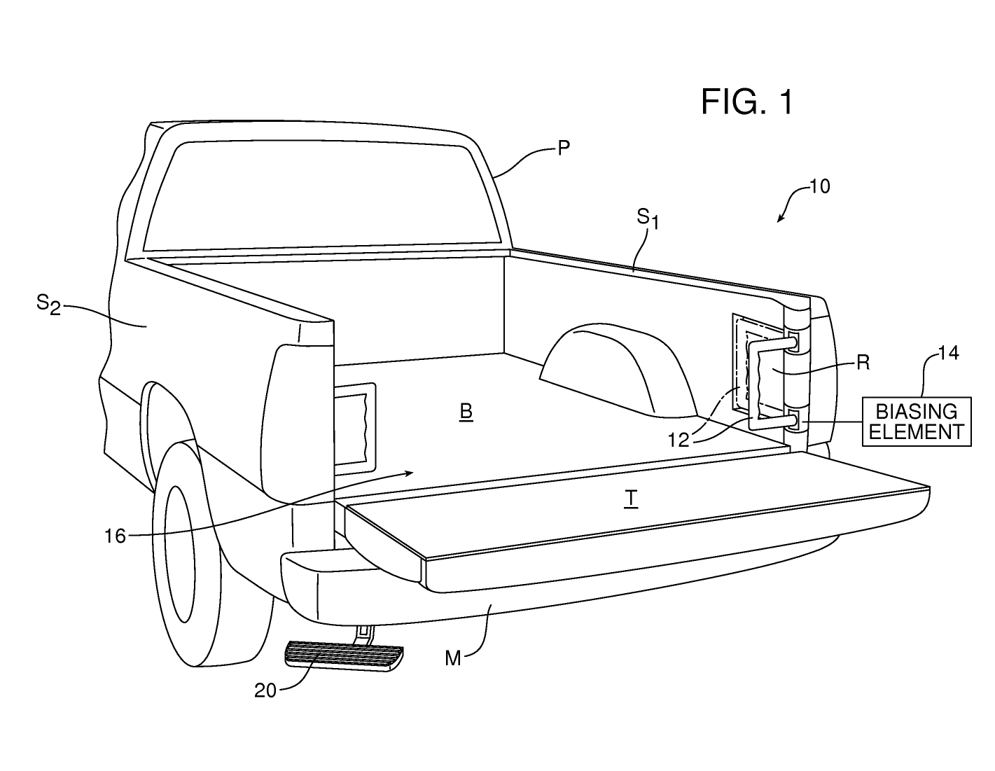

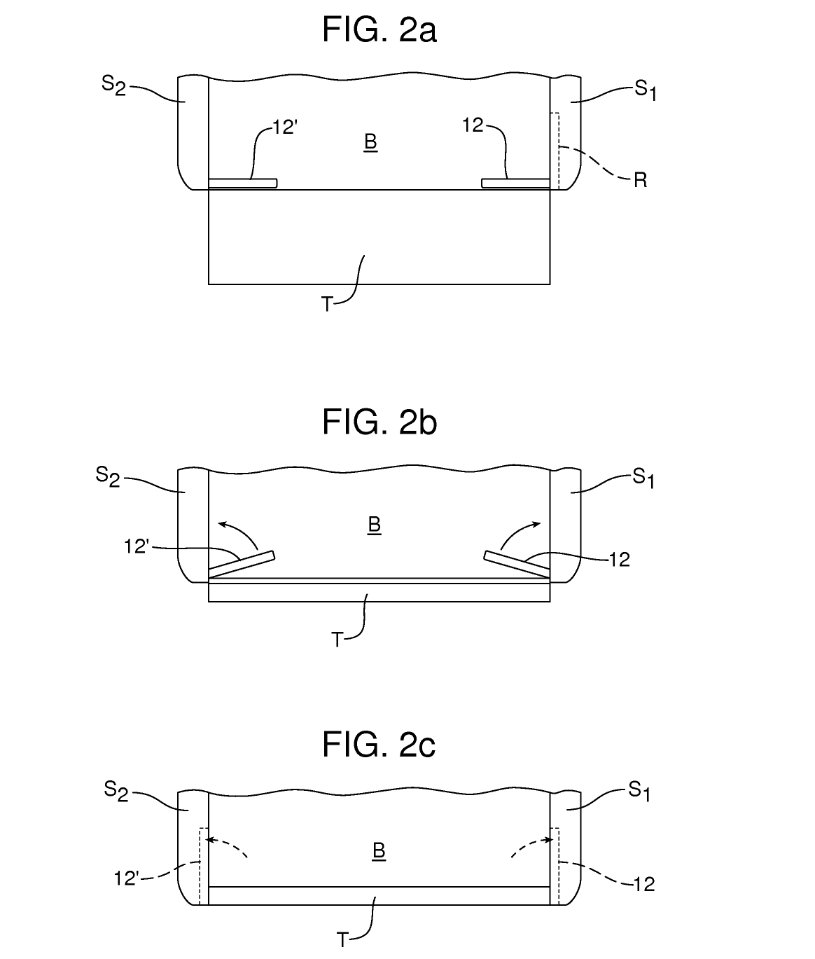

Reference is now made to FIGS. 1, 2a, 2b and 2c illustrating a motor vehicle, in the form of a pickup truck P having a cargo bed B, cargo bed sidewalls S₁, S₂ and a tailgate T. The pickup truck P is also equipped with a first embodiment of the access handle system 10. That access handle system 10 includes a handle 12 that is connected to a biasing element 14, such as a torsion spring, for displacing the handle from the storage position shown in phantom line within the recess R of the sidewall S₁ and a deployed position shown in full line extending partially across the tailgate opening 16 when the tailgate T is opened.

As illustrated in FIGS. 2a-2c, when the tailgate T is closed, the inner wall of the tailgate engages the handle 12 (see FIG. 2b) so as to displace and hold the handle in the home position within the recess R (see FIG. 2c). As should be appreciated from viewing FIGS. 1 and 2a-2c, a second handle 12′ may be provided on the cargo bed sidewall S₂ opposite the first handle 12 at the other side of the tailgate opening 16 if desired. As further illustrated, one or both handles 12, 12′ may be associated with a step 20 to aid in gaining access to the cargo bed B. Note, for example, the step 20 provided adjacent the bumper M below the handle 12′. While the embodiment illustrated in FIGS. 1 and 2a-2c incorporates the biasing element 14 for biasing the handle 12 and/or 12′ into the deployed position whenever the tailgate T is opened, it should be appreciated that the handle 12 and/or 12′ may be provided without the biasing element. Such a handle 12, 12′ may be manually manipulated between the storage and deployed positions as desired. A detent or other structure such as a lock may be provided to hold the handle 12 in any appropriate position.

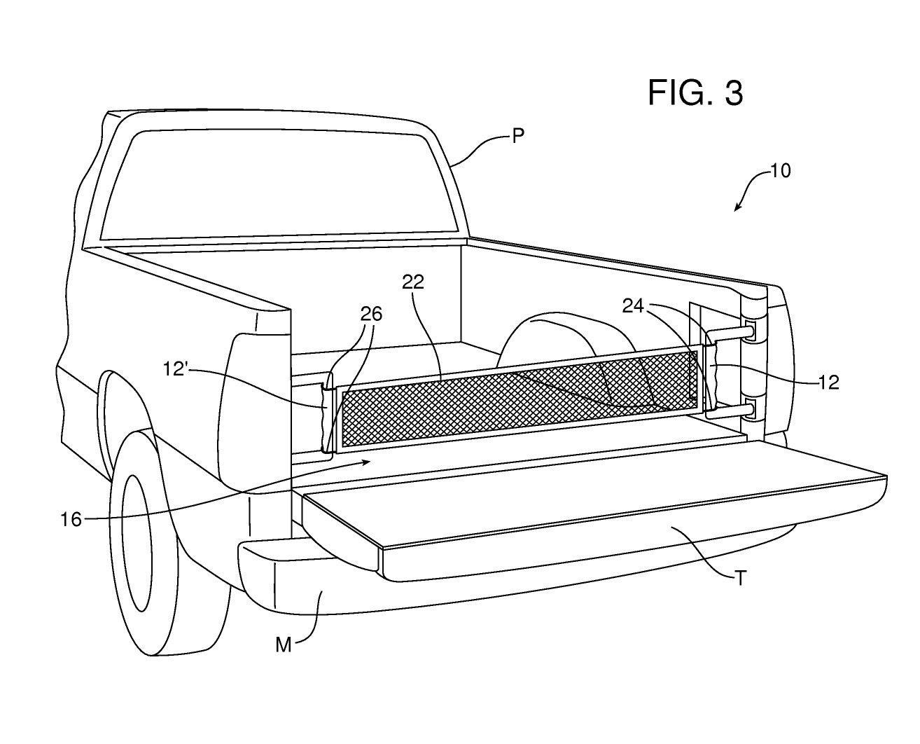

Reference is now made to FIG. 3 illustrating another embodiment of the access handle system 10. In this embodiment, the access handle system 10 includes a stretchable, flexible cargo net 22 including hooks 24 at a first end and hooks 26 at a second end. As illustrated, the cargo net 22 may be stretched to extend across the tailgate opening 16 between the handles 12 and 12′ by connecting the hooks 24 to the handle 12 and the hooks 26 to the handle 12′.

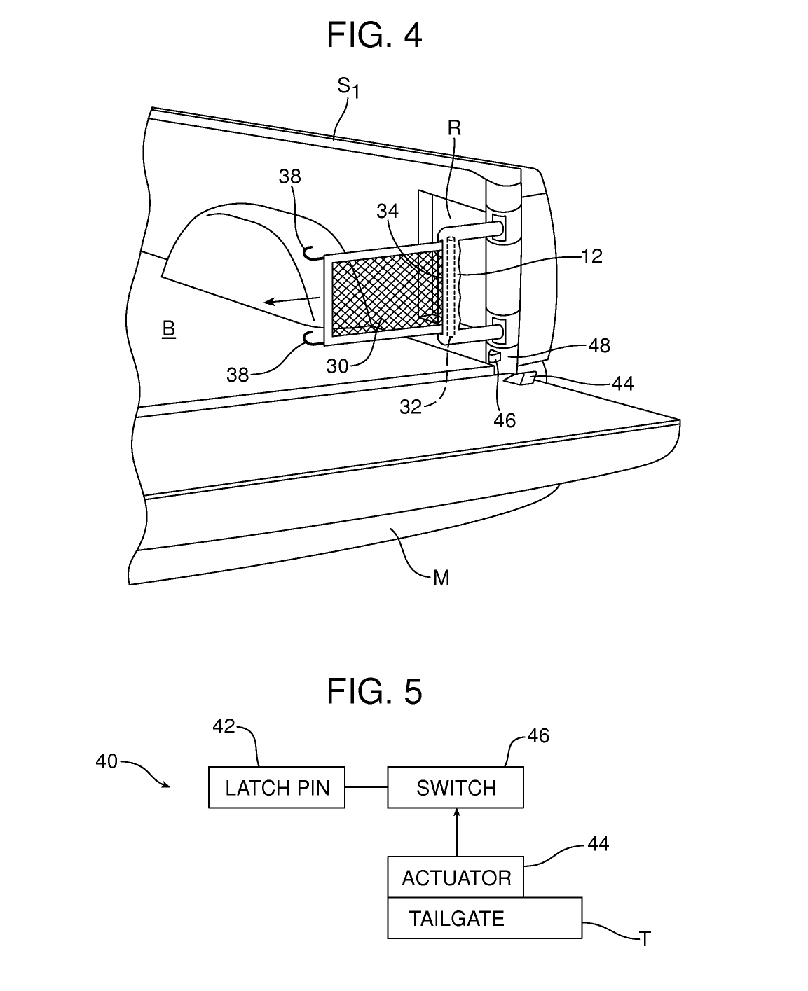

Reference is now made to FIG. 4 illustrating yet another possible embodiment of the access handle system 10. In this embodiment, a retractable cargo net 30 is provided on a take-up reel 32 held inside the handle 12. The net extends through a slot 34 in the handle and may be extended from the handle across the tailgate opening 16 until the hooks 38 at the distal end engage the handle or other structure at the opposite side of the cargo opening (not shown).

The embodiment of the access handle system 10 illustrated in FIGS. 4 and 5 also includes a lock assembly generally designated by reference numeral 40. The lock assembly 40 includes a spring loaded or solenoid controlled latch pin 42. When the tailgate T is opened and the handle 12 is moved into the fully deployed position, the spring loaded latch pin 42 engages the handle 12 to secure the handle in the deployed position. However, when the tailgate T is closed, an actuator 44 engages the switch 46 on the vertical handle support 48, depressing that switch and withdrawing the latch pin 42 from engagement with the handle 12. Accordingly, the handle 12 is then free to rotate or pivot back to the storage position within the recess R when engaged by the inner wall of the tailgate T.

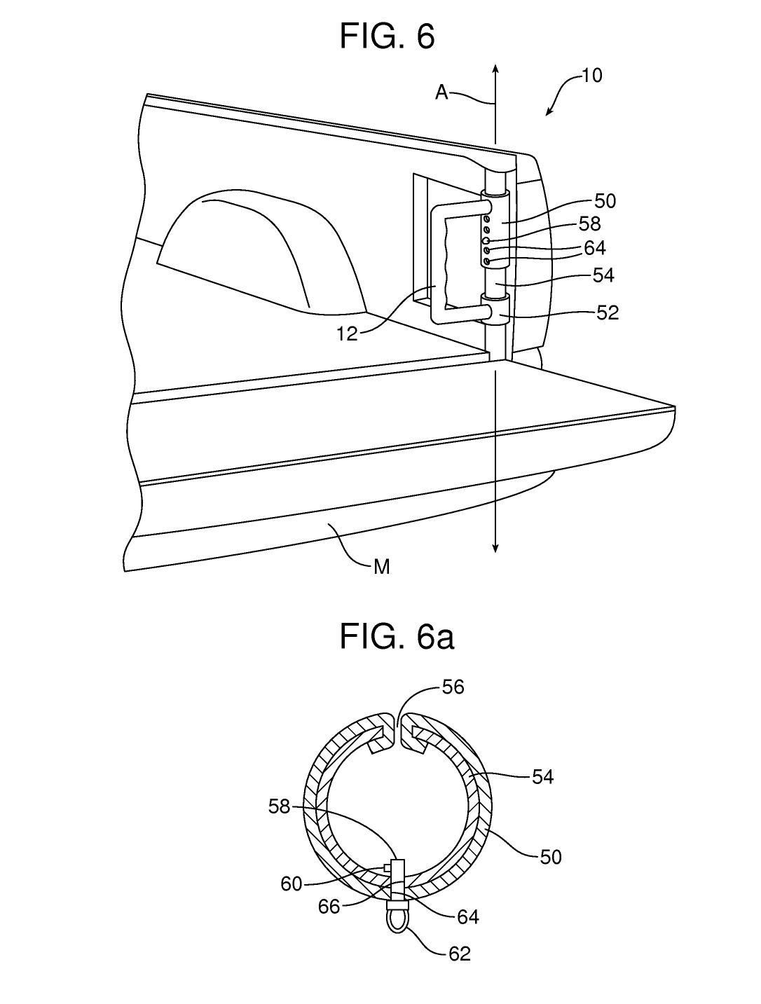

Reference is now made to FIG. 6 illustrating yet another embodiment of the access handle system 10. In this embodiment, the handle 12 is mounted by an upper sleeve 50 and a lower sleeve 52 to a vertical support 54 that rotates in the sidewall S₁ about an axis A that extends in a vertical direction. As should be appreciated, the handle 12 pivots about or around the axis A when it is displaced between the storage and deployed positions. As further illustrated in FIG. 6a, the handle support 54 includes a guide track or slot 56 that extends along the longitudinal axis of the support. The sleeves 50, 52 ride along the slot 56 so that the height of the handle 12 may be adjusted along the axis A in a vertical direction.

The height of the handle 12 may be locked in a first, a second and even additional positions by means of a pin 58 including a detent 60 and a pull ring 62. More specifically, as shown in the illustrated embodiment, the upper sleeve 50 includes a series of apertures 64. The height of the handle 12 is vertically adjusted until one of those apertures 64 is aligned with a single aperture 66 in the handle support 54. The pin 58 is then inserted into the aligned apertures 64, 66 (see FIG. 6a) to secure the handle 12 in the selected vertically adjusted position, the spring loaded detent 60 holding the pin 58 in place until an individual utilizes the pull ring 62 to remove the pin 58 in order to change the vertical adjustment position. Of course, it should be appreciated that the locking mechanism for securing the handle 12 in a selected vertical position may take any other form suitable for such a purpose.

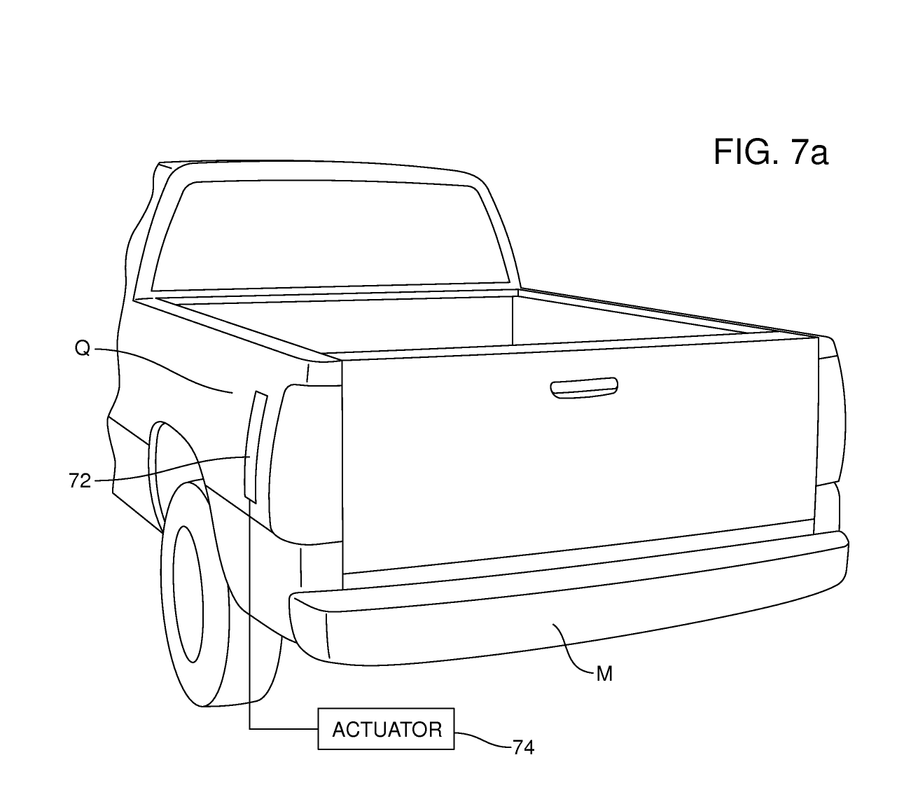

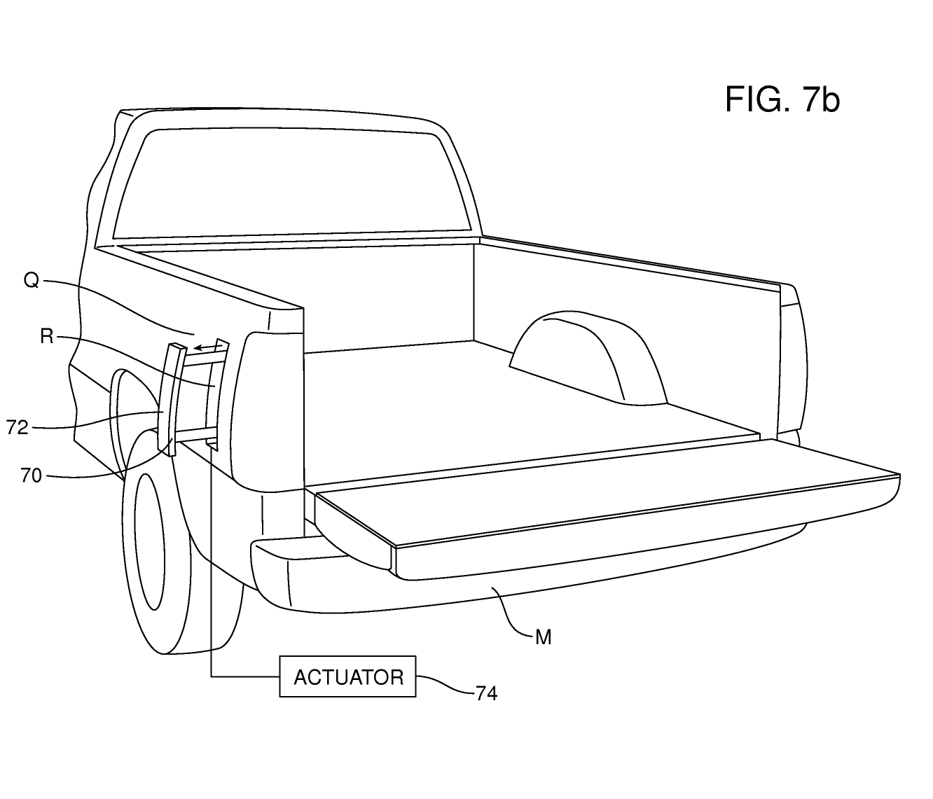

Reference is now made to FIGS. 7a and 7b illustrating yet another embodiment of the access handle system 10. In this embodiment, a recess R is provided in the rear quarter panel Q of the pickup truck P. The handle 70 is carried on the quarter panel Q and is displaceable between a home position wherein the handle is received in the recess R with the facing 72 of the handle with the outer surface of the quarter panel (see FIG. 7a) and a deployed position wherein the handle and the facing project outwardly from the quarter panel (see FIG. 7b). An actuator 74 in the form of a biasing element, a drive motor, a solenoid or other appropriate structure is provided to automatically deploy the handle 70 when the tailgate T is opened, and/or automatically displace the handle to the storage position when the tailgate T is closed or to automatically deploy the handle when the tailgate is opened and displace the handle to the storage position when the tailgate is closed.

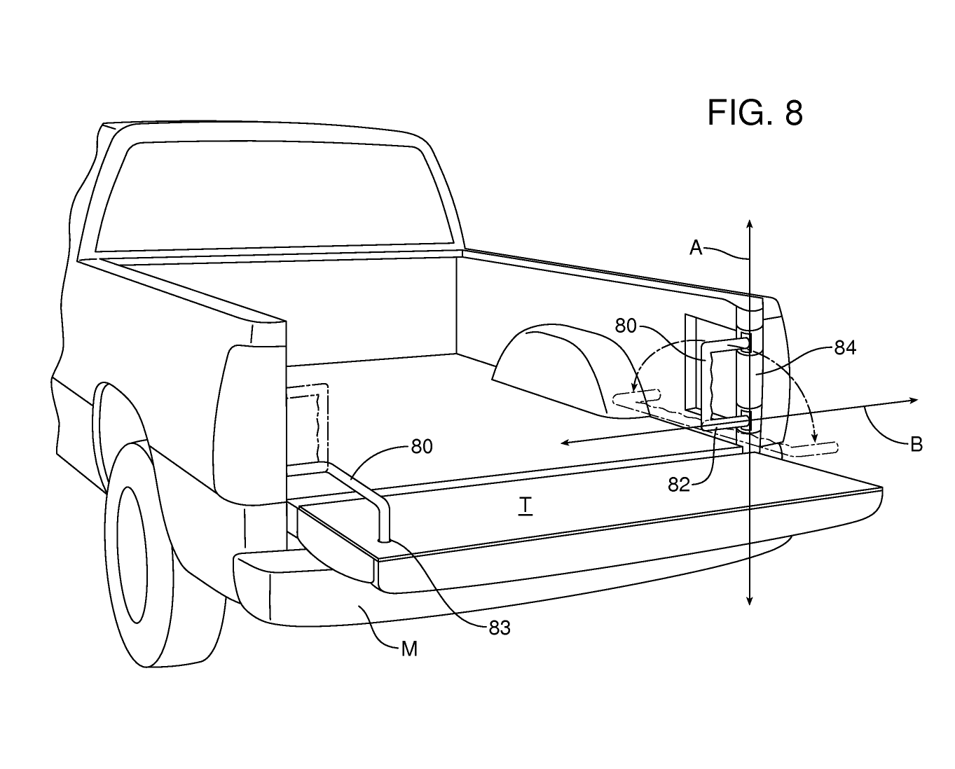

Reference is now made to FIG. 8 illustrating yet another embodiment of the access handle system 10 wherein the handle 80 is articulated about a single point to allow for added adjustability. In the embodiment illustrated in FIG. 8, the handle 80 may be pivoted forwardly or rearwardly by pivoting the arm 82 in the handle support 84 about the axis B. Here it should be noted that the axis B is substantially perpendicular to the axis A about which the handle is displaced between the home and deployed positions. As shown at left in FIG. 8, the tailgate T may include a receptacle 83 that receives and supports the end of the handle 80.

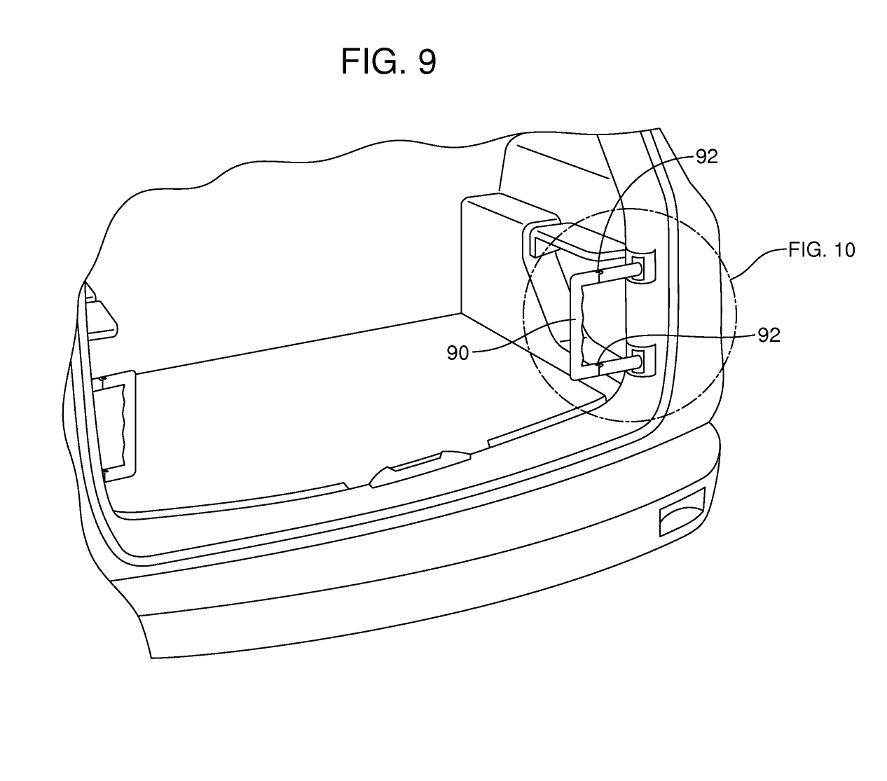

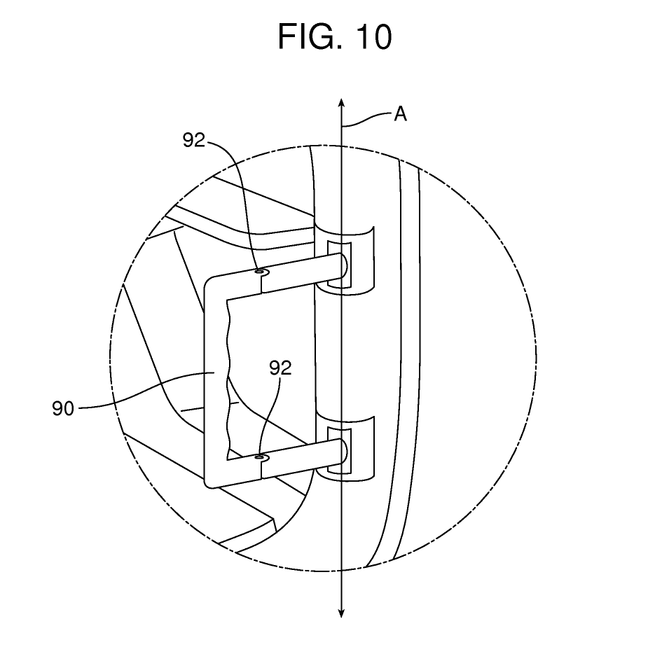

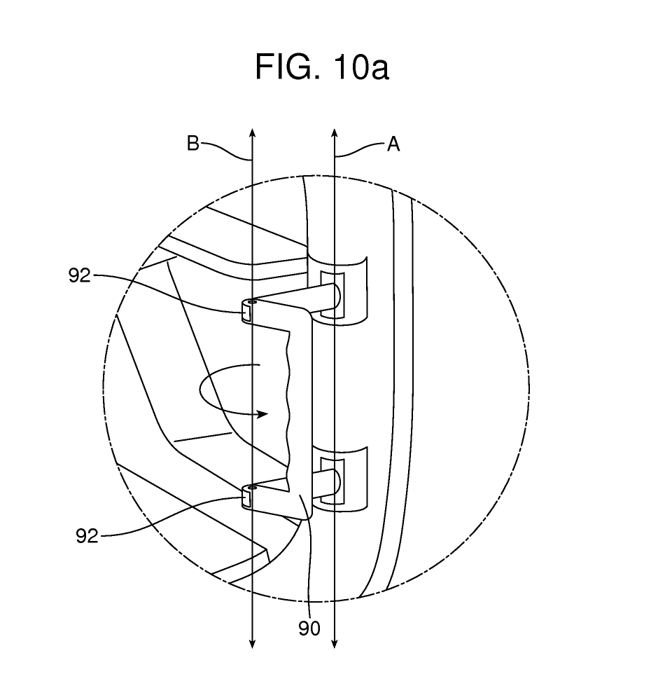

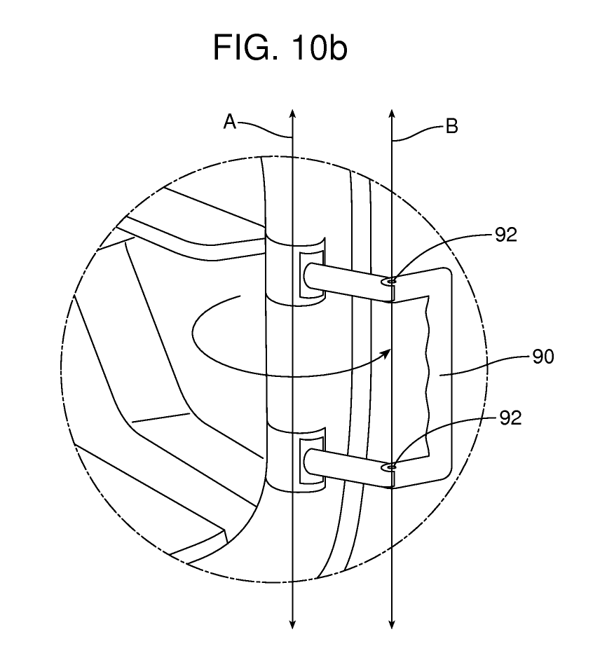

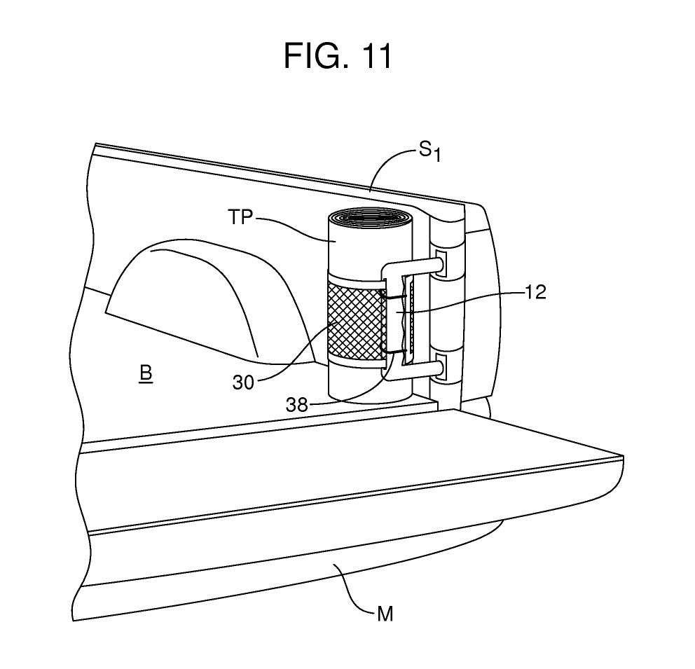

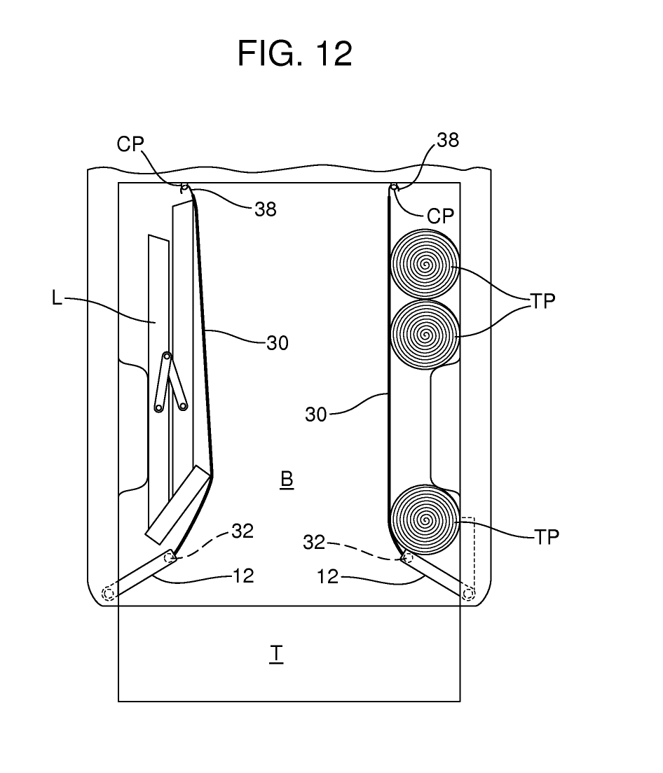

In the embodiment illustrated in FIGS. 9, 10, 10a and 10b, the handle 90 is articulated at two aligned points 92 offset from the axis A. Thus, the handle 90 may be further pivoted and adjusted as illustrated in FIGS. 10a and 10b around the axis A and the axis B as shown.

The foregoing has been presented for purposes of illustration and description. It is not intended to be exhaustive or to limit the embodiments to the precise form disclosed. Obvious modifications and variations are possible in light of the above teachings. For example, while the embodiment illustrated in FIG. 1 shows a range of pivotal movement between the storage and deployed positions of about 90°, that range of movement may encompass 270° or more and include multiple deployment positions. Anyone of those angular deployment positions may include a detent or locking pin to secure the handle in the desired angular orientation.

Further, it should be appreciated that the embodiment of the access handle system 10 incorporating a retractable cargo net 30 on the handle 12, as illustrated in FIG. 4, provides still greater versatility and utility than previously set forth. For example, as illustrated in FIG. 11, the cargo net 30 may be paid out from the handle 12, wrapped around an item such as the tar paper TP and the hooks 38 connected back to the handle in order to hold the tar paper in position. As further illustrated in FIG. 12, such a cargo net 30 may also be attached by the hooks 38 at other connection points CP, such as at the front wall of the bed B, to hold a ladder L, tar paper TP or other items not shown and prevent them from shifting in the bed during vehicle operation. All such modifications and variations are within the scope of the appended claims when interpreted in accordance with the breadth to which they are fairly, legally and equitably entitled.

What is claimed:

1. An access handle system for a motor vehicle including a closure, comprising:
a handle; and
a biasing element for displacing said handle from a storage position to a fully deployed position when said closure is opened.

2. The handle system of claim 1, wherein said handle is received in a recess in a body panel of said motor vehicle when in said storage position.

3. The handle system of claim 2, wherein said recess is formed in a sidewall of a cargo bed.

4. The handle system of claim 1, further including a lock assembly for securing said handle in at least one of said deployed position and said storage position.

5. The handle system of claim 4, wherein said lock assembly includes a latch pin for engaging and holding said handle in said deployed position and an actuator on said closure for releasing said latch pin when said closure is closed so that said handle is free to be displaced into said storage position.

6. An access handle system for a motor vehicle including a closure, comprising:
a handle carried on said motor vehicle adjacent said closure, said handle being (a) pivotally displaceable between a storage position and a deployed position about an axis A and (b) adjustable between at least a first position and a second position by translation along said axis A.

7. The handle assembly of claim 6 further including a lock assembly for securing said handle in at least one of said home position, said deployed position, said first position and said second position.

8. The handle assembly of claim 6 further including a flexible cargo net and a payout reel for said flexible cargo net, said flexible cargo net having a distal end including a hook for securing said distal end to said handle.

9. The handle assembly of claim 6, further including a second handle carried on said motor vehicle adjacent an opposite side of said tailgate closure.

10. The handle assembly of claim 9, wherein said second handle is (a) displaceable between a storage position and a deployed position about an axis B and (b) adjustable between at least a third position and a fourth position by translation along said axis B.

11. The handle assembly of claim 10, further including a flexible cargo net having a first hook at a first end and a second hook at a second end whereby said flexible cargo net may be connected to and extend between said handle and said second handle.

12. The handle assembly of claim 10, further including a flexible cargo net and a payout reel for said flexible cargo net, said payout reel being housed within said handle.

13. The handle assembly of claim 6, wherein said handle is fixed to a handle support that rotates about said axis A and said handle support including a guide track along which said handle translates.

14. The handle assembly of claim 6, wherein said handle is articulated at a single point perpendicular to the axis A.

15. The handle assembly of claim 6, wherein said handle is articulated at two points offset from said axis A.

16. The handle assembly of claim 6, further including a biasing element for displacing said handle from said storage position to a fully deployed position when said closure is opened.

17. The handle assembly of claim 16, wherein said handle is received in a recess in a body panel of said motor vehicle when in said storage position.

18. An access handle system for a motor vehicle, comprising:
a recess provided in a rear quarter panel of said motor vehicle; and
a handle carried on said rear quarter panel and displaceable between a home position, wherein said handle is received in said recess with a facing of said handle flush with an outer surface of said rear quarter panel, and a deployed position wherein said handle and said facing project outwardly from said rear quarter panel.

19. The access handle system of claim 18 wherein said handle is automatically deployed when a closure of said motor vehicle is opened.

20. The access handle system of claim 18, wherein said handle is automatically displaced to the storage position when a closure of said motor vehicle is closed.
